(19) United States
(12) Patent Application Publication
(10) Pub. No.: US 2010/0195856 A1
(43) Pub. Date: Aug. 5, 2010

(54) METHOD FOR DETERMINING THE ACOUSTIC FEEDBACK BEHAVIOR OF A HEARING DEVICE ON THE BASIS OF GEOMETRIC DATA OF AN EAR

(75) Inventors: Alexander Grafenberg, Effeltrich (DE); Andre Steinbuss, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/697,544

(22) Filed: Feb. 1, 2010

(30) Foreign Application Priority Data
Feb. 2, 2009 (DE) 10 2009 007 079.6

(51) Int. Cl. H04R 25/00

(52) U.S. Cl. 381/317

(57) ABSTRACT

A method at least partially determines acoustic feedback of a hearing device worn by a hearing device wearer. The method includes a detection of the geometry of the auditory canal and/or the concha of the ear of the hearing device wearer and a determination of the feedback from the detected geometry. The thus determined feedback can also be used to adjust a hearing device. This is advantageous in that a measurement of the feedback does not have to be implemented.

### CROSS-REFERENCE TO RELATED APPLICATION

This application claims the priority, under 35 U.S.C. §119, of German application DE 10 2009 007 079.6, filed Feb. 2, 2009; the prior application is herewith incorporated by reference in its entirety.

### BACKGROUND OF THE INVENTION

### Field of the Invention

The invention relates to a method for determining acoustic feedback in a hearing device worn by a hearing device wearer, a computer program product for implementing the inventive method and a method for adapting a hearing device with an inventively determined feedback.

If acoustic couplings exist in a hearing device between a microphone and a receiver, feedback effects, for instance “whistling” can occur. FIG. 1 shows a schematic representation of a hearing device 1 with acoustic feedback. The hearing device 1 is located in an acoustic environment. A signal 7 received by a microphone 2 of the hearing device 1 is inter alia amplified in a signal processing unit 5 and output again by way of a receiver 3 of the hearing device 1. An acoustic coupling from the receiver 3 back to the microphone 2 takes place by way of a physical feedback path 4. The received signal 7 thus consists of the total of an incident useful signal 6 and the signal across the feedback path 4. Feedback whistling occurs as a result of the feedback, if both the amplitude and also the phase conditions are fulfilled. Sound artifacts nevertheless already appear if these conditions are only approximately fulfilled.

One method of suppressing feedback consists in determining the open loop gain (OLG). For the OLG measurement, the signal path of the hearing device 1 is separated for instance, test tones of different frequencies or noises are generated in the hearing device, output by way of the receiver 3 and received by the microphone 2 by way of the feedback path 4. The level of the received, fed-back signal is determined upstream of the separation point. The OLG represents the difference in terms of the original level of the test tones and/or the noise, on the basis of which OLG the maximum possible amplification of the (feedback threshold) hearing device 1 without feedback whistling can be determined. The test tones and/or noises are perceived as disturbing by some hearing device wearers. Furthermore, the measurement itself is time-consuming for both parties.

Alternatively to an individual measurement of the OLG, statistical curves can be picked up from a hearing device data base for the adjustment of the maximum amplification of the hearing device.

### SUMMARY OF THE INVENTION

It is accordingly an object of the invention to provide a method for determining the acoustic feedback behavior of a hearing device on the basis of geometric data of an ear which overcome the above-mentioned disadvantages of the prior art methods and devices of this general type. It is a further object of the invention to specify a method for adapting a hearing device based on the geometric data.

The invention claims a method for at least partially determining an acoustic feedback of a hearing device worn by a hearing device wearer. The method includes the steps of detecting the geometry of the auditory canal and/or the concha of the ear of the hearing device wearer and determining the feedback from the detected geometry. The advantages here are a shorter adaptation time for acousticians and hearing device wearers and no interfering measurement noises for the hearing device wearer.

In a development of the invention, an open loop gain can be determined from the determined feedback. As a result, a robust and precise measuring method is ensured.

In a further embodiment, the determination of the feedback can take place by comparing the detected geometry of the ear and the geometry of the hearing device.

Furthermore, the comparison can take place by a virtual projection of three-dimensional data of the geometry of the hearing device into the detected three-dimensional geometry of the ear.

The method can advantageously include the following steps of determining a distance of a sound outlet point from the ear to a microphone of the hearing device, and/or determining the alignment of a receiver and/or sound tube of the hearing device in the auditory canal and/or determining the impedance of a backward sound in the auditory canal as a function of the properties of an earmold of the hearing device.

The invention also specifies a computer program product with a computer program, which contains software for implementing the inventive method, if the computer program is executed in a control unit.

The invention also specifies a method for adapting a hearing device with an inventively determined feedback, with the feedback determined from geometric data being used to adjust parameters of the hearing device.

Other features which are considered as characteristic for the invention are set forth in the appended claims.

Although the invention is illustrated and described herein as embodied in a method for determining the acoustic feedback behavior of a hearing device on the basis of geometric data of an ear, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram for describing the principle of acoustic feedback in a hearing device; and

FIG. 2 is a flow chart showing a method for determining an acoustic feedback according to the invention.

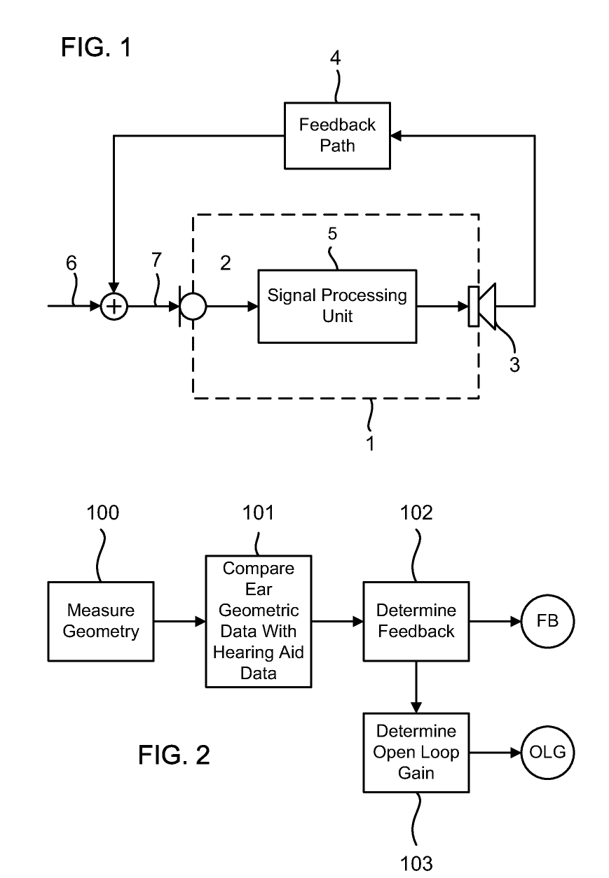

### DETAILED DESCRIPTION OF THE INVENTION

Referring now to the figures of the drawing in detail and first, particularly, to FIG. 2 thereof, there is shown a flow chart of a method for determining acoustic feedback FB of a hearing device worn by a hearing device wearer. In step 100, the geometry of the auditory canal and the concha of the ear of the hearing device wearer is measured, in which an in-the-ear hearing device or an earmold of a behind-the-ear hearing device is worn. The determination of the geometry can take place for instance by laser scanning, computed tomography or magnetic resonance tomography. This completely three-dimensional scan of the ear allows an acoustic measurement to be omitted. In the subsequent step 101, the three-dimensional geometric data thus detected is compared with the geometric data of the hearing device. In particular, the distance of the sound outlet point from the ear to the microphone of the hearing device and the alignment of the receiver or the sound tube in the auditory canal are determined. The impedance of the rear sound in the auditory canal can likewise be determined as a function of the geometry and the material property of the earmold of the hearing device used (hard otoplastic, open or closed elastic screen). In step 102, the frequency-dependent acoustic feedback FB is determined from this comparison of step 101. In the subsequent step 103, the open loop gain (OLG) is determined from the determined feedback FB.

An optical measurement of an auditory canal is described for instance in published, non-prosecuted German patent application DE 10 2005 059 550 A1, corresponding to U.S. patent publication No. 2007/0153296 A1. The associated measuring apparatus includes a confocal distance sensor, in which the beam path of the illumination and measurement light is diverted by a rotatably mounted reflector. In this way, a circumferential side wall of the cavity can be measured by inserting at least one end, on the object side, of the measuring apparatus into the cavity (ear) to be measured.

1. A method for at least partially determining acoustic feedback of a hearing device worn by a hearing device wearer, which comprises the steps of:
detecting a geometry of at least one of an auditory canal and a concha of an ear of the hearing device wearer; and
determining the acoustic feedback from the geometry detected.

2. The method according to claim 1, which further comprises determining an open loop gain from the acoustic feedback.

3. The method according to claim 1, which further comprises determining the acoustic feedback by comparing the geometry of the ear with a geometry of the hearing device.

4. The method according to claim 3, which further comprises performing the comparison via a virtual projection of three-dimensional data of the geometry of the hearing device in the geometry of the ear being a three-dimensional geometry of the ear.

5. The method according to claim 1, which further comprises performing at least one of:
determining a distance of a sound outlet point from the ear to a microphone of the hearing device;
determining an alignment of one of a receiver and a sound tube of the hearing device in the auditory canal; and
determining an impedance of a rear sound in the auditory canal in dependence on properties of an earmold of the hearing device.

6. A computer-readable medium having computer-executable instructions to be executed in a control unit for performing a method for at least partially determining acoustic feedback of a hearing device worn by a hearing device wearer, which comprises the steps of:
detecting a geometry of at least one of an auditory canal and a concha of an ear of the hearing device wearer; and
determining the acoustic feedback of the hearing device from the geometry detected.

7. A method for adapting a hearing device with a determined feedback determined from a geometry of at least one of an auditory canal and a concha of an ear of a hearing device wearer, which comprises the steps of:
adjusting parameters of the hearing device from the determined feedback determined from geometric data.
